(19) United States
(12) Patent Application Publication
(10) Pub. No.: US 2004/0254830 A1
(43) Pub. Date: Dec. 16, 2004

(54) Limited resource allocation system and methods

(76) Inventor: Richard Andrew Gardiner, Newbury, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/863,611

(22) Filed: Jun. 8, 2004

Related U.S. Application Data
(60) Provisional application No. 60/478,494, filed on Jun. 13, 2003.

(51) Int. Cl. G06F 17/60

(52) U.S. Cl. 705/13

(57) ABSTRACT

This invention relates to methods of allocating limited resources, such as the granting of property interests in public parking spaces. In one embodiment, an inventory of public parking spaces is taken, potential leaseholders in the parking spaces are identified based on a prioritization scheme, and one of the identified private parties is granted a property interest in the parking space. The private party may then exercise exclusive control over the space, including subleasing, maintenance and repair, beautification, and enforcement.

### FIELD OF THE INVENTION

This invention relates to a system and methods of allocating limited resources. In one application, the invention concerns granting property interests in public parking spaces and, more particularly, methods of reducing competition for urban residential parking spaces while enhancing the revenue realized by municipalities from granting interests in the public parking spaces.

### BACKGROUND INFORMATION

One of the most persistent and troublesome problems confronting urban residents throughout the United States and in other industrialized countries is finding an affordable, safe parking space within a reasonable distance to either their home or office. Snow and rain can trigger extreme reactions and anger between people competing for a parking space, often resulting in civil suits and law enforcement actions. Many large cities use neighborhood parking district permits to allocate public parking along their public streets in residential areas. Unfortunately, this method fails because of the lack of sufficient existing resident parking spaces. In Boston, for example, it has been reported that the city allocates 4.5 parking permits for every one parking space in certain neighborhoods. In addition, the need for municipalities to maintain a parking enforcement department adds an administrative burden to local governments.

Furthermore, the lack of funds available to many municipalities and their inability to create new sources of income other than property taxes often results in the curtailment or elimination of social programs that address the basic needs of the community. This lack of funding, coupled with a fixed amount of physical space further limits the development of additional parking as the city grows. In difficult economic times, municipalities are constantly searching for new sources of income to maintain current program budgets while being pressured by its citizens and the press to solve the many critical problems faced by cities, counties, and towns as a result of under funding.

Thus, a need exists for a method that provides reliable access to convenient parking spaces for urban residents that is also economically self-sustainable, and that provides a source of substantial additional income to municipalities.

### SUMMARY OF THE INVENTION

Accordingly, the present invention provides a system and methods for municipalities to lease limited resources, such as public street parking spaces, such that urban residents have reliable, ongoing, reserved access to a parking space near their residence or place of employment.

In general, the invention relates to methods of allocating public parking spaces to private individuals while enhancing revenues of the municipalities that have jurisdiction over the spaces. Such methods allow homeowners, condominium owners, renters, or local commuters to be assured that a legal, safe parking space is available in a convenient location whenever needed. The individual may use the parking space in any number of ways. They may park their own vehicle, they may sublease the space to another individual, or leave the space open to the public. Creating legal rights to parking spaces that are adjacent to or somehow otherwise associated with privately owned properties will provide additional ownership incentives and increase personal pride in the neighborhoods. Such methods will also create an initial infusion of funds in the first few years of the program as the spaces are allocated and leased, as well as consistent, dependable future revenue streams for the municipalities that lease the parking places. The program will provide funding to create and maintain additional parking spaces, improve streetscape features, and neighborhood safety. As a result, the value and desirability of the properties in the neighborhoods participating in the program will increase.

By leasing specific spaces to individual property owners, the administrative costs and lease payments due can be collected at the beginning of the lease through mortgages and loans, or automatically added to property taxes and other fees paid to the municipality on a periodic basis. Enforcement and maintenance duties can be allocated based on parameters of the program and how each municipality implements the program.

In one aspect, the invention relates to a system and method of granting a property interest in public parking spaces. The method includes publicly distributing notifications indicating the availability of property interests in public parking spaces, receiving, in response to the notifications, indications of interest from one or more private parties regarding the acquisition of a property interest in the parking spaces, selecting one of the private parties, and granting a property interest in the parking space to the selected private party.

In one embodiment of the invention, the parking spaces are located on a public street. The notification can include an application on which a party can indicate an interest in obtaining a property right in a public parking space. The private party can be an institution such as a hospital or a private school. The property interest can be an ongoing interest, which in some embodiments can be a long-term lease. In some embodiments, the selection can be made according to a predetermined selection process. The selection process can be based on the proximity of the parties' residence to the parking space, and in some embodiments the selected party's residence may be adjacent to the parking space. The selection can be made based on a priority assigned to the one or more private parties. The selection can be made based on financial considerations, such as the assessed value of property owned by the private parties. The method can also include placing a visible indication of ownership substantially proximate to the parking space. In some embodiments, the method can further include placing an electronic monitoring device substantially proximate to the parking space that determines if a vehicle is using the parking space. The electronic monitoring device can detect if a vehicle using the parking space is permitted to use the parking space. The method can also include sending electronic notification from the electronic device to the private party, or in some cases, a towing service, when a vehicle is using the parking space that is not permitted to do so. The method can also include receiving instructions from the private party to remove an unauthorized vehicle from the space.

In another aspect, the invention relates to a system and method of collecting revenue for the ongoing use of a public parking space by a private party. The method includes determining a fee associated with the ongoing use of a public parking space, granting a property interest in the public parking space to a private party, and collecting the fee.

The public parking space can be on a public street. The fee can be determined based on an assessed value of a property located substantially adjacent to the parking space. The property interest can be a long-term lease. The private party can have an existing property interest in property located substantially adjacent to the parking space. The private party can be an institution such as a hospital or a private school. The fee can be collected from the party to whom the interest was granted, or in some embodiments, from a financial institution on behalf of the private party. The fee can be collected upon the granting of the property interest, or in some cases, can be collected periodically.

In a third aspect, the invention relates to a system and method of obtaining an ongoing property interest in a public parking space. The method includes receiving notification that a property interest is a public parking space is available, submitting an application to obtain the property interest, receiving the property interest, and exercising ongoing control over the use of the parking space.

In one embodiment of the invention, the parking space is located on a public street. The property right can be a long-term lease. The application can include the opportunity to indicate that the parking space should remain available to the public. Exercising control over the parking space can include subleasing the space, selling a timeshare interest in the space, or transferring the property interest to another party. The method can further include monitoring use of the parking space. The monitoring can be done through the use of visible indications of ownership, such as a sign or vehicle decal, or in some embodiments, wireless electronic detection apparatus, including radio frequency identification systems. The method can also include placing a transmitter in one or more vehicles permitted to use the parking space. In some embodiments, the method can further include placing an electronic monitoring device substantially proximate to the parking space that determines if a vehicle is using the parking space. The electronic monitoring device can detect if a vehicle using the parking space is permitted to use the parking space, and in some embodiments can send a notification to the private party or a towing service if an unauthorized vehicle is using the parking space.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a diagram illustrating the physical environment in which the invention is conducted.

FIG. 2 is a flowchart illustrating, at a summary level, one possible embodiment of the invention.

FIG. 3 is a flowchart illustrating one possible embodiment of the Preliminary Phase of the invention.

FIG. 4 is a flowchart illustrating one possible embodiment of the Inventory Phase of the invention.

FIG. 5 is a flowchart illustrating one possible embodiment of the Design Phase of the invention.

FIG. 6 is a flowchart illustrating one possible embodiment of the Start-up Phase of the invention.

FIGS. 7A and 7B are diagrams illustrating one possible embodiment of the signage and demarcation elements of the invention.

FIG. 8 is a flowchart illustrating one possible embodiment of the Maintenance Phase of the invention.

### DETAILED DESCRIPTION

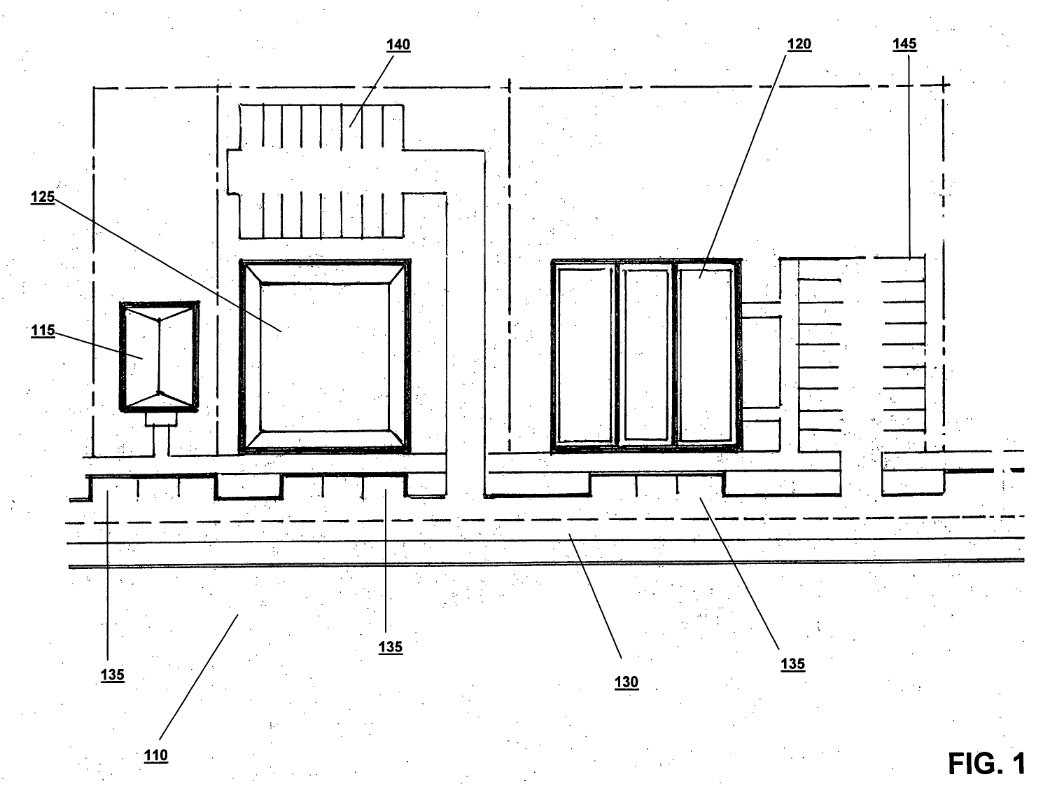

FIG. 1 illustrates an urban residential neighborhood 110 in which the invention may be implemented. Such neighborhoods often have a mix of single-family dwellings 115, multi-family dwellings 120, and commercial establishments 125 located along public streets 130. In many cases, the public streets 130, in addition to lanes of traffic, provide spaced on-street parking in various locations 135. However, these neighborhoods 110 can be more densely populated than surrounding suburban neighborhoods, and due to their close proximity to large employment centers, on-street parking is often at a premium. A commercial establishment 125 may have a dedicated, off-street parking lot 140 for their employees, and in some cases, multi-family dwellings 120 may also have an off-street parking lot 145 located on their property. However, due to the desirability of these locations, many multi-tenant dwellings may choose not to have allocated off-street parking, and those that do may not have a sufficient supply to meet the demands of their tenants. Likewise, an owner of a single family home 115 may decide there are better uses for garages or land, such as a play area for children or extra livable space, or may not have the available unused space for off-street parking. Thus, individuals who do not have dedicated, private parking spaces are relegated to “street parking.” Generally, this requires a driver to roam throughout the neighborhood 110 in search of a legal, vacant parking spot 135 on a public street 130, and often a similarly frustrating search for loose change to feed a parking meter.

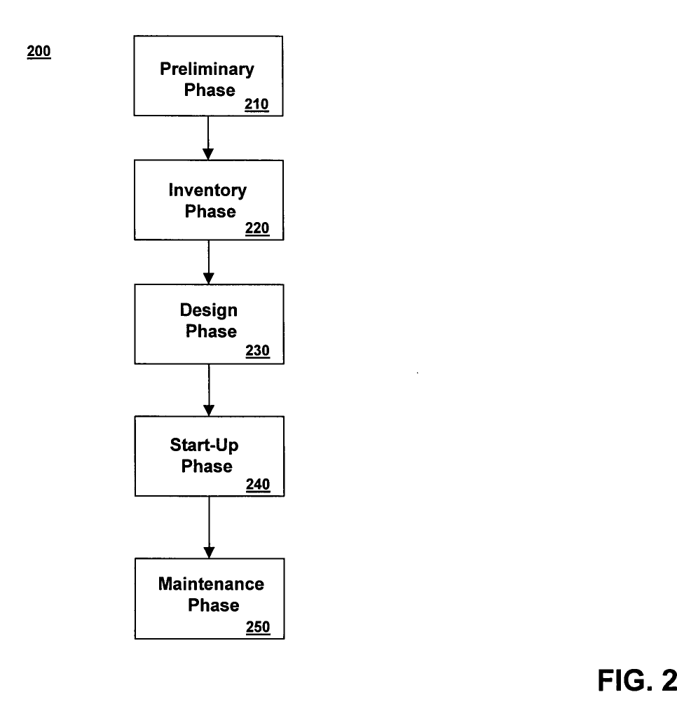

FIG. 2 illustrates one embodiment of a method 200 for allocating public parking spaces through a municipal lease program (the “Program.”) The method 200 can be divided into phases, with each phase having a series of steps. The ordering and dependencies among the phases and tasks are described herein as one possible embodiment of the method, and are not meant to limit the scope of the invention in any way. The method 200 begins with a Preliminary Phase 210, which includes the creation and approval of the administrative, financial, and political entities necessary to implement and manage the Program, including the authorization and creation of a Municipal Parking Lease Department (the “Department”) to administer the Program. In some embodiments, the municipality may outsource a subset of the Department's responsibilities to a private company. An Inventory Phase 220 follows, wherein the Department determines the inventory of spaces, assigns space numbers, and creates a database of spaces that will be made available to the public through the Program. In some embodiments, the Inventory Phase 220 may run concurrently with the Preliminary Phase, or in some cases, precede it. The Department then starts the Design Phase 230, during which many of the aesthetic aspects of the Program—such as the types of markings and signage to be used—as well as the infrastructure to implement and run the Program are determined. This may include items such as the design or procurement of computer systems, the hiring and training of employees, the design of the application and the process for approval, as well as any legal work needed to secure the payment process, among others. Again, many of these tasks may be done simultaneously with tasks in other phases. A Start-Up Phase 240 includes the initial contact with the public, the implementation and data population of all necessary management systems. This phase continues until the inventory of spaces is allocated. The Start-Up Phase 240 can be repeated as more parking spaces become available, or as leases expire and the spaces are reallocated. A Maintenance Phase 250 follows, during which the tasks needed to manage and administer the Program on an ongoing basis are executed by the Department. This includes collection, enforcement, maintenance and repair, or other tasks, some of which may be delegated to the private party leasing the space, and others of which may remain the responsibility of the Department, or other municipal entities.

Unlike previous attempts at solving individual societal and environmental problems that are classified as “social benefit activities” and are administered by nonprofit foundations and religious organizations, this method 200 solves numerous community and environmental problems through the application of innovative capitalism. As a self-financing economic business, the method 200 can solve these problems previously not addressed by other social programs through the establishment of a reliable source of future revenue.

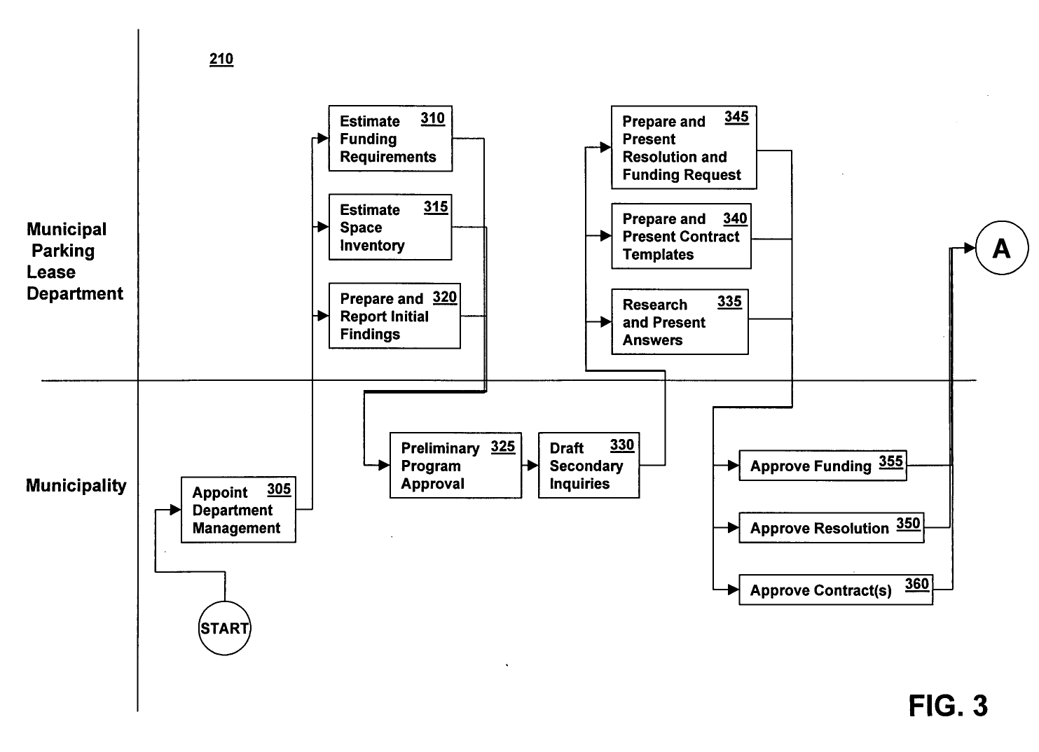

FIG. 3 illustrates, in greater detail, one possible embodiment of the Preliminary Phase 210 of the method 200. Initially, the municipality creates the Department responsible for designing the details of the Program, including appointing Department management (step 305). In some embodiments, the appointment of management can be done according to executive powers vested in elected officials such as a city council or a board of selectmen, or in some embodiments, the management can be hired through more conventional means such as posting job opportunities in local newspapers, on world-wide-web sites, or in periodicals. Once appointed, the Department management prepares the estimated funding requirements (step 310) for the start-up and ongoing administration of the Program. The funding includes money for administrative salaries, construction contracts, development of a computer system and related information technology infrastructure, marketing and public relations costs, among others. In addition to a preliminary funding request, the Department compiles an estimate of the inventory of spaces (step 315) that are available for the Program, and thus the Department can determine the expected revenues the plan will generate for the municipality. The compilation can be an estimate based on sampled data, or could be determined from existing systems that track metered parking spaces. The Department then prepares an initial report (step 320) for presentation to the municipal officials. In some embodiments, the municipality may choose to involve community members in the process to provide additional insights and alternative viewpoints regarding the Program at town meetings, or other open forums. Based on the initial report, the city council or selectmen provide preliminary approval (step 325) and draft secondary inquiries (step 330) for the Department to investigate and authorizes the preparation of follow-on reports.

With preliminary approval, the Department researches and prepares detailed reports for presentation to the municipality. For example, the Department presents more detailed administrative and operational aspects of the Program (step 335) based on answers to the follow-on questions posed by city council members, members of the community, or other interested parties. The Department also prepares and presents template contracts (step 340) for any functions that are to be outsourced, such as the construction and installation of signage and the development of information systems necessary to support the Program. In addition, the Department prepares and presents a proposed resolution and funding request (step 345) to the municipality.

Based on the proposed resolution, the municipality then approves the resolution by passing an ordnance establishing the Program (step 350) and approves the funding the organization (step 355) of the City Lease Program. At the same time, or in separate meetings, the proposed contracts are approved for use (step 360), generally with input from other city officials such as attorneys and contracts administrators.

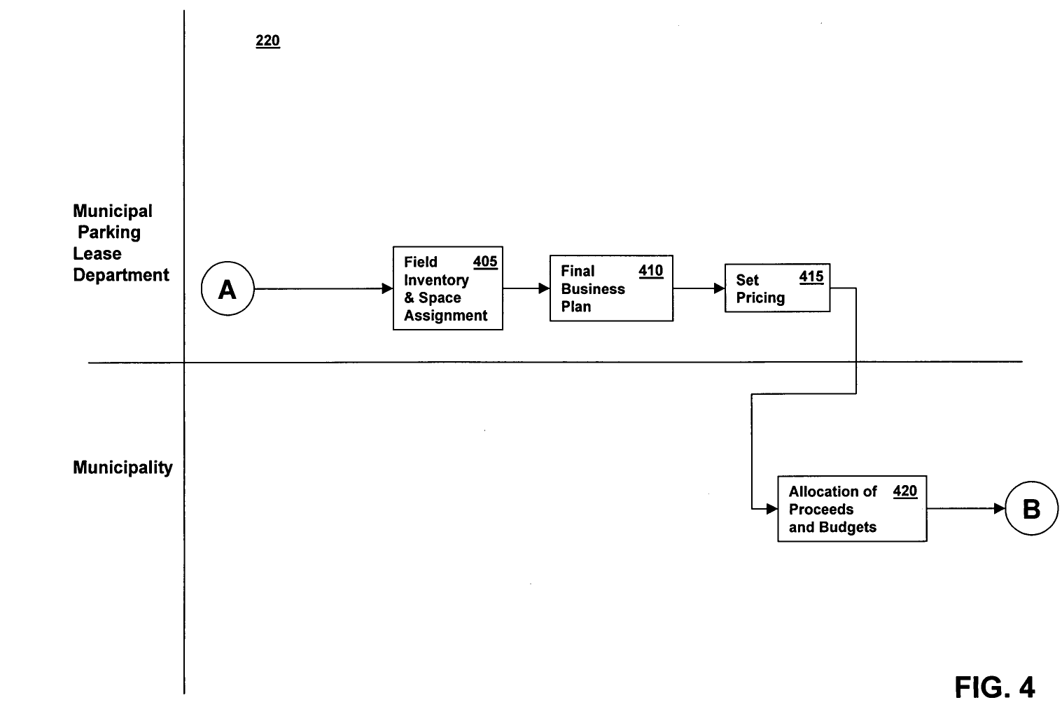

FIG. 4 illustrates one possible embodiment of the Inventory Phase 220 of the method 200. Upon approval by the municipality, the Department performs a more detailed field inventory (step 405) and space numbering assignments, including determining which spaces will be included in the Program, and to which property(s) each space will be initially offered. The Department also finalizes any details of the business plan (step 410) and pricing (step 415). These steps include, among other tasks, determining the type and duration of the property interest to grant under the Program, setting a formula for the length and cost of the leases and any annual maintenance and repairs fees, determining the rights of the leaseholder to sublet or sell a time share in one or more leased spaces, designing the method of demarcation of the parking spaces, determining dispute resolution procedures, and finalizing the staffing and administrative set up of the Department. In one embodiment, the property interest is a 20-year, renewable lease from the municipality to the selected private party. The municipality receives full payment for the lease upon granting the lease, and the private party can borrow the money from a financial institution, thus avoiding a large up front expense and potentially allowing some or all of the periodic loan payments to be tax-deductible.

An example of a dispute resolution procedure includes appointing a member of the Department as a community ombudsman, who, guided by a set of rules, determines the outcome of certain disputes. For example, a set of rules may stipulate that fifty percent (50%) or greater of the parking space fronting on a particular residential property (as determined by a review of the residential property line survey and the parking lot space survey) be assigned to that residential property. In some instances, exceptions may be granted for neighboring properties having less then 50% of the parking space fronting it as accessible parking spaces. This may be due to street elements or rules beyond the control of the property owner, such as a fire hydrant, a bus stop, handicapped parking, a curb cut, etc. In such a case, if the neighboring residential property has more then one public parking space available to it, the property owner could petition the Department for relief and be awarded a parking space otherwise allocated to the neighboring property. Any decisions made by the Department could be appealed through administrative or other legal avenues such as the courts. Based on these and other details of the business plan, the municipality can allocate the proceeds of the Program (step 420) in its current and future budgets.

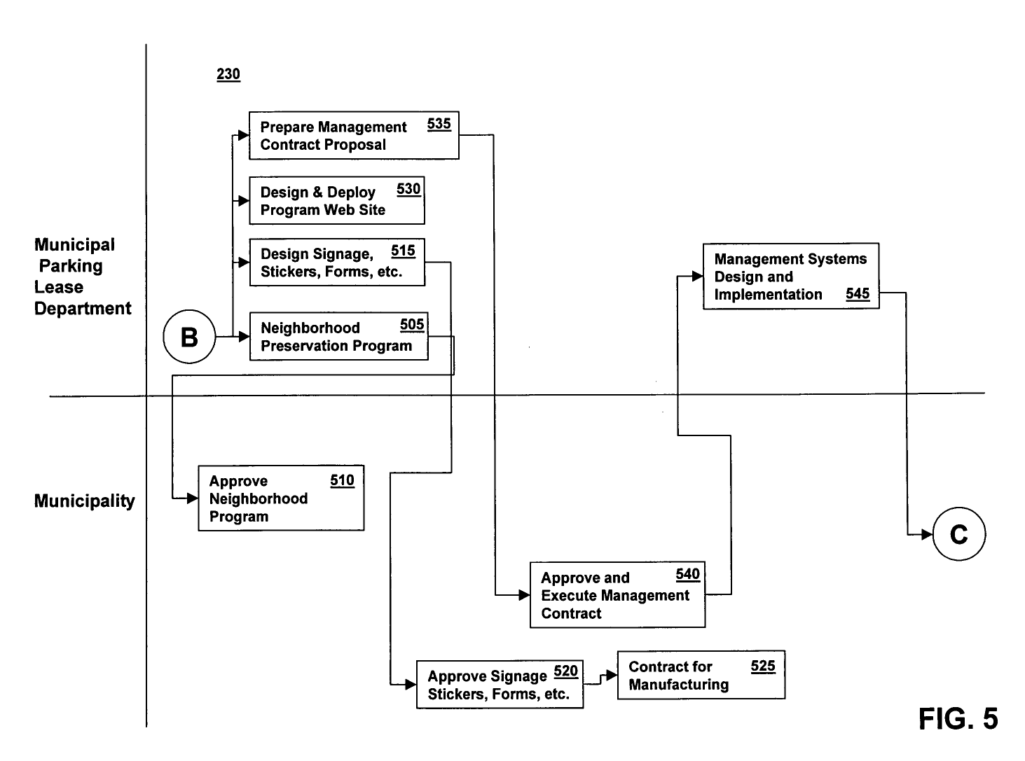

FIG. 5 illustrates, in greater detail, one possible embodiment of the Design Phase 230 of the method 200 for implementing the invention. With the final business plan and the appropriate financial infrastructure in place, the Department begins designing and implementing specific features of the Program.

In one embodiment, the Program can be coupled with a neighborhood preservation program. As part of the Program, the Department sets the funding parameters for such a program, (step 505), which the municipality then approves (step 510). In some embodiments where the creation and maintenance of economic sustainability for resident neighborhood parking and their safety is determined to be a priority, a percentage of the income generated by the Program is returned to the individual neighborhood programs. The actual percentage and the method of allocation are optional. However, even a small percentage (e.g., 5%) of funds being returned to the neighborhood based on the spaces within a designated area committed to a neighborhood trust could be used to fund initiatives such as the design and construction of additional residential parking areas the design and construction of “Streetscape Improvements” for improving sidewalks, street lighting, trees, and signage, to assist long term rental residents of the neighborhood to purchase homes in the neighborhood, as well as other initiatives that increase the aesthetics, security, and desirability of properties in the neighborhood.

Continuing in reference to FIG. 5, the Department designs (step 515) the signage, any vehicle decals or stickers, the application, and other physical elements of the Program. In some embodiments, the design is done in-house by Department staff, or in some cases subcontracted to private companies or individuals. The designs are approved (step 520) by the municipality, and, if needed, contracts are let (step 525) to private companies to manufacture the items. The Department may also determine that one appropriate means for the distribution of information about the Program is the World Wide Web, and therefore decide to design and deploy or contract for such a web site service (step 530). The web site may include general information about the Program and the Department, such as contact information and mission statements, but could also include maps of the neighborhoods participating in the Program, online application and/or payment processes, means for reporting violations, as well as other interactive elements.

In addition to the web site, other management systems are needed to implement and operate the Program. The Department prepares contract management proposals (step 535) for each of the systems. In some cases, the Department may have the authority to publicize the contracts and select vendors, while in other situations the final authority may still rest with the municipality. In such cases, the municipality approves and executes the contracts (step 540), after which the design and implementation (step 545) of the systems can begin. Examples of such systems include the application process and supporting paperwork, training programs for employees of the Department, communications equipment, a communications plan, enhancements to financial systems to accept electronic payments, as well as other procedural systems and supporting computer systems. With the business plan approved and the infrastructure and systems in place, the Program can then begin the Start-up phase 240 of the method 200.

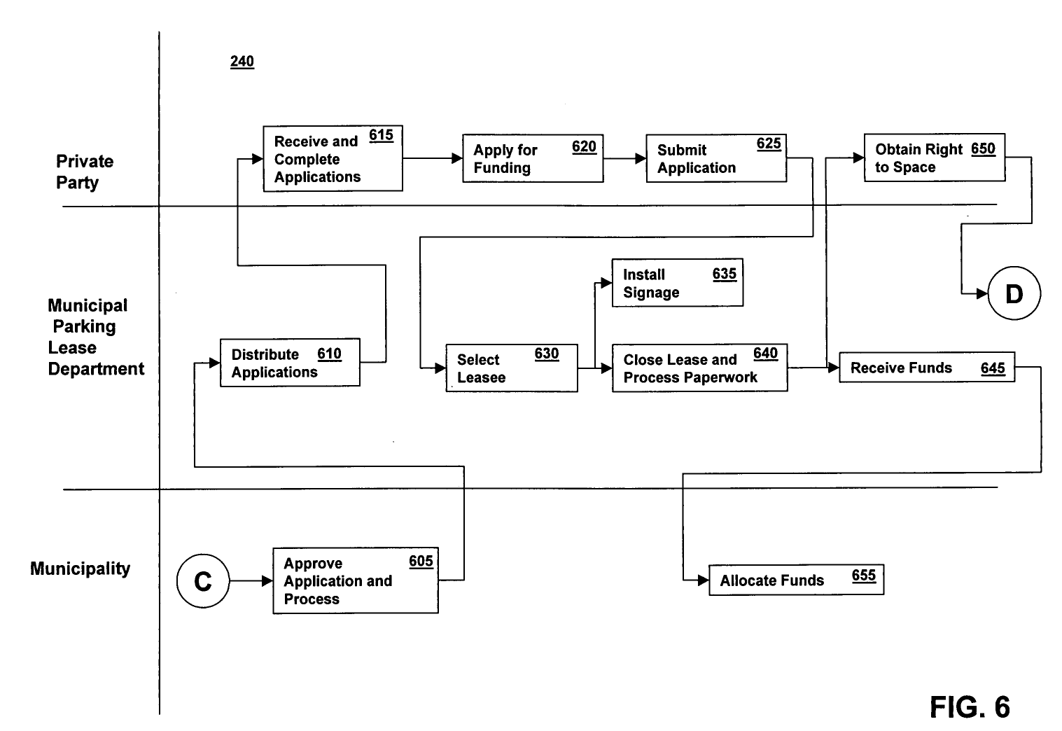

FIG. 6 illustrates one embodiment of the start-up phase 240 of the method 200. The municipality approves the application and associated process(es) (step 605), and provides the initial go-ahead to the Department. The distribution of the applications (step 610) to the public can be accomplished through numerous means such as mailings, Internet postings, newspaper advertisements, or other public notices. Once advertised, private parties receive and complete the applications (step 615), and either subsequently, or in some cases concurrently, apply for funding (step 620) through a mortgage company, bank, or other financial institution by submitting a loan application. The institution may be the same institution that processes the private party's current mortgage on the property adjacent to the parking space, or in instances where the applicant is renting the property adjacent to the space, the financing may be provided by an unrelated institution, or an institution selected by the municipality to facilitate the financing of the Program. With funding secured, the private party submits their completed application (step 625) to the Department, or its authorized subcontractor.

Once the applications are received, the Department selects a leasee (step 630). In some embodiments, there may only be one application for a particular space—whereas in other cases there may be multiple parties applying for the same spaces. The selection process can include a priority schema to assist the Department in determining the selected party. One such example of a priority schema is detailed below:

TABLE 1
Selection Priority Schema

| | |
|---|---|
| First Priority | Owner/Occupant of private property adjacent to |
| | available space |
| Second Priority | Family Member of Owner Occupant. |
| Third Priority | Longest residing condominium owner to shortest |
| | residing condominium owner of adjacent private |
| | property |
| Fourth Priority | Longest residing apartment dweller to shortest residing |
| | apartment dweller in adjacent private property |
| Fifth Priority | Resident living on the block where the space is located |
| Sixth Priority | Neighboring resident within some number of blocks of |
| | the parking space as determined by the Department, |
| | the neighborhood residents, or other means |
| Seventh Priority | Commuters |

The Department (or an authorized subcontractor) then installs the signage, and any electronic monitoring apparatus (step 635). In some embodiments, the installation can be done earlier in the process, such as at the inventory stage; however, by delaying the installation, the selected leasee can provide input (or potentially additional funding) for the signage and demarcation elements. In some cases, the municipality may approve multiple sign designs, and allow the selected leasee to select from the multiple designs. Furthermore, if the implementation includes wireless monitoring devices, the Department can synchronize any communications equipment to the leasee's telephone, as well as provide the leasee with the necessary transponders for vehicles authorized to use the spaces.

Once the proper paperwork has been received, reviewed, and processed, the lease is closed (step 640) and the funds are received by the Department (step 645), either directly from the leaseholder, or in cases where the lease is funded through a mortgage or loan, from the financial institution. The private party then obtains the right to use the space (step 650) pursuant to any additional terms or conditions stipulated by the Department and in any operating procedures associated with the Program. The funds can then be forwarded to the municipality, and allocated (step 655) according to budgetary decisions.

In some embodiments, certain stages of the process, or the entire process, can be outsourced to a private company that performs various functions of the Department. The company may, in conjunction with an agreement with the municipality, withhold a percentage of the collected fees to cover operating expenses and profits.

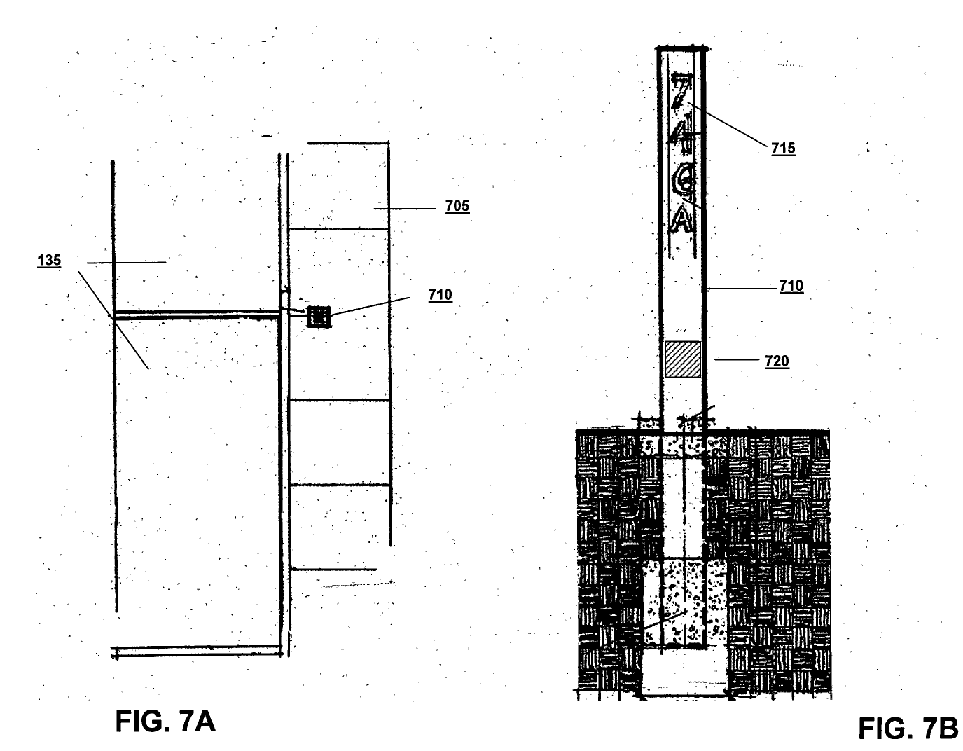

FIGS. 7A and 7B illustrate one possible embodiment of the location and signage for leased parking spaces 135 along a sidewalk 705 adjacent to the street in which the spaces 135 are located. A post 710 at a location adjacent to two spaces 135 operates as notification for the spaces 135. Numbering and/or lettering 715 designates the space number, and in some cases also includes the address of the property to which the space has been allocated. An electronic monitoring device 720 detects the existence of a vehicle in the space 135 though motion sensors, light beams, or other detection apparatus. In some cases the device 720 is attached to the post 710; whereas, in some cases the device 720 in enclosed in the post 710 to avoid vandalism, theft, and exposure to weather.

In one embodiment, the Department provides the leaseholder with an electronic transponder to be placed in the leaseholder's vehicle. Upon parking in the space 135, the electronic monitoring device 720 detects that a vehicle is in the space 135 and searches for a corresponding signal from the transponder in the leaseholder's vehicle. If the correct signal is received by the device 720, no action is taken. If, however, no signal is received, the device 720 transmits a signal to the leaseholder via standard telephone, wireless messaging, email, or other electronic communications apparatus. The leaseholder then contacts a towing service authorized by the Department or the municipality to have the vehicle removed. If the vehicle belongs to a guest of the leaseholder, the notification is ignored. In some embodiments, the device 720 also notifies the Department or municipality, if either entity is involved in enforcing the lease.

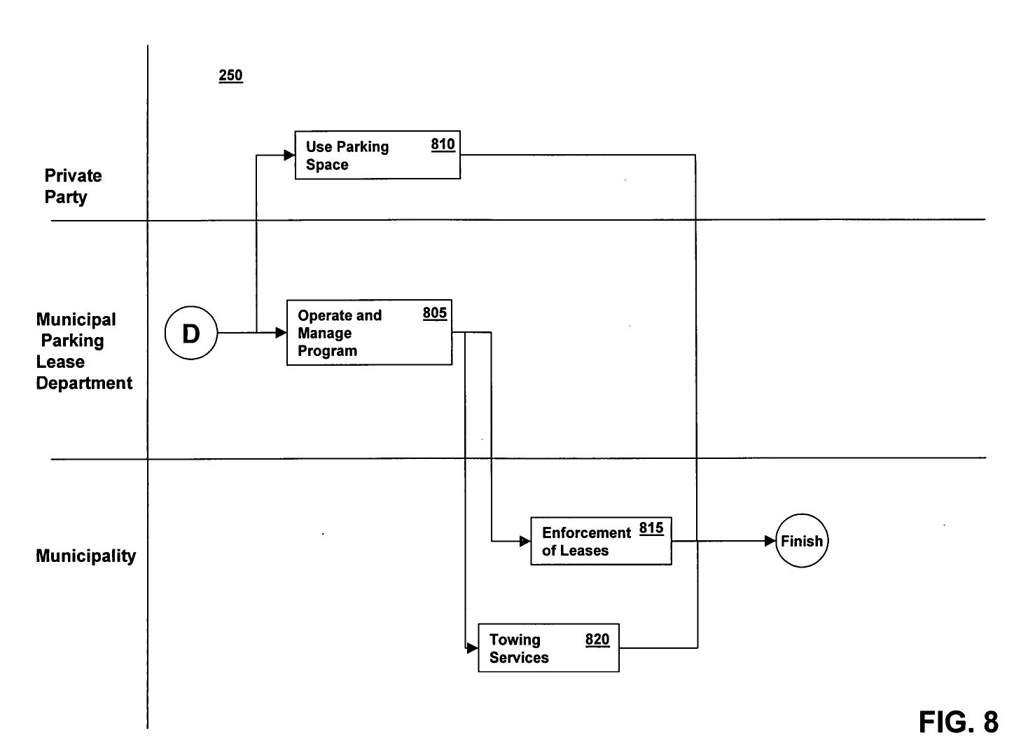

FIG. 8 illustrates one possible embodiment of the Maintenance Phase 250 of the method 200. Upon granting the rights to use the parking spaces 135 to private parties, the Department continues to operate and manage the Program (step 805), adhering to the operational policies and procedures designed and implemented during prior phases, and the private party can make use of the space (step 810) at any time. In some cases, the Department and the private party rely on the municipality for services such as the enforcement of the leases (step 815), towing services (step 820) as well as others. In other cases, the monitoring and enforcement of the space can be done by the private party, who may in turn contract with a private service for towing, snow removal, general maintenance etc. In some instances, the municipality may provide lists of approved contractors as references for the private parties.

In some embodiments, the right to make certain physical modifications to the parking space can be delegated to the private party. The private party may decide to augment any signage, or in some cases decorate the space with plantings, murals, and the like, so long as the changes comply with Department, municipal, or neighborhood guidelines. In other cases, the Department would have exclusive rights to make physical modification or improvements to the parking space or signpost.

To encourage the adoption of the program and the purchase of long term parking space leases, the private party may, in some cases, sublease the space to another party, thus creating an “open market” for the buying and selling of rights to parking spaces. However, such an incentive may encourage price gouging. In some cases, the Department may draft and adopt a policy governing the rules relating to the subleasing of the spaces. For example, one such policy would include the following rules: (1) the price for the subleasing of a public parking space could not be more then twice its original lease price calculated over the life of the long term lease, divided by the number of years, and then by the months in a year; (2) a time-share sublease, less then 24 hours, would be calculated on the same maximum basis divided by the percent (%) of hours sublet in a given day; (3) no individual or legal entity would be allowed to purchase or otherwise “harvest” multiple parking space leases or subleases for the purpose of controlling the parking in a given area; (4) any leaseholder caught requiring additional payments of any form, not covered in the written sublease agreement, automatically forfeits his right to the space and the municipal department can terminate the original lease agreement and advertise for the space's availability; and (5) the Department provides a standard “Sublease Agreement,” that the original leaseholder is required to use in all subletting or time-share arrangements. A copy of all sublease agreements will be forwarded to the Department and filed with the appropriate agencies.

In some cases such as price gouging, unauthorized subleases and physical modifications, as well as others, it may become necessary for the municipality to terminate the lease and re-advertise the availability of the parking space. In such cases, the original long-term lease purchase monies would be forfeited by the leaseholder, therefore discouraging the activities mentioned above. Administrative and legal appeal processes would be made available to leaseholders that believed their lease was unfairly terminated, or that they are due a refund of some or all of their payments.

Various phases of the invention may be implemented on one or more computer systems. The systems may include data storage modules, memory devices, input apparatus, application modules, data processing devices, and one or more outputs such as visual screen displays, electronic data transmissions, and the communication of web pages. For example, a database can be used to store the inventory of available parking spaces and various characteristics of the spaces such as the location, the leaseholder, payment terms, payment status, as well as other data relevant to implementing the invention. The application modules can provide on-line applications to interested parties via the Internet, such that applicants can complete the application using a standard personal computer and a web browser. The completed application can then be submitted electronically, matched with one or more parking spaces, and queued for review by the Department. The application logic may also be used to receive electronic communications from the monitoring device 720 and compare the transmitted data with data stored in the data storage module to determine if the vehicle using the space is authorized to do so.

The data processing devices may implement the functionality of the present invention as software on a general purpose computer. In such an embodiment, the program may be written in any one of a number of high-level languages, such as FORTRAN, PASCAL, C, C#, C++, java, Tcl, or BASIC. Further, the program can be written in a script, macro, or functionality embedded in commercially available software, such as EXCEL or VISUAL BASIC. Additionally, the software could be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A method of granting a property interest in public parking spaces, comprising:
publicly distributing notifications indicating the availability of property interests in public parking spaces;
receiving, in response to the notifications, indications of interest from one or more private parties regarding the acquisition of a property interest in the parking spaces;
selecting one of the private parties; and
granting a property interest in one or more of the parking spaces to the selected private party.

2. The method of claim 1 wherein the public parking spaces are located on a public street.

3. The method of claim 1 wherein the notification includes an application on which a party can indicate an interest in obtaining a property right in a public parking space.

4. The method of claim 1 wherein the property interest is an ongoing interest.

5. The method of claim 4 wherein the property right is a long-term lease.

6. The method of claim 1 wherein the private party is an institution.

7. The method of claim 6 wherein the institution is one of a hospital or a private school.

8. The method of claim 1 wherein the selection of the private party is done based on the proximity of the private parties' residence to the parking space.

9. The method of claim 8 wherein the selected private party's residence is adjacent to the one or more parking spaces.

10. The method of claim 1 wherein the selection of the private party is based on a predetermined priority scheme.

11. The method of claim 1 wherein the selection of the private party is done based on financial considerations.

12. The method of claim 11 wherein the financial considerations is based on an assessed value of property owned by the private party.

13. The method of claim 1 further comprising placing a visible indication of property rights substantially proximate to the parking space.

14. The method of claim 1 further comprising placing an electronic monitoring device substantially proximate to the parking space, the device determining if a vehicle is using the parking space.

15. The method of claim 14 wherein the electronic monitoring device further detects if a vehicle using the parking space is permitted to use the parking space.

16. The method of claim 15 further comprising sending an electronic notification from the electronic monitoring device to the selected private party when a vehicle is using the parking space that is not permitted to do so.

17. The method of claim 15 further comprising sending an electronic notification from the electronic monitoring device to a towing service when a vehicle is using the parking space that is not permitted to do so.

18. The method of claim 1 further comprising receiving instructions from the selected private party to remove unauthorized vehicles from the parking space.

19. A method of collecting revenue for the ongoing use of a public parking space by a private party, comprising:
determining a fee associated with the ongoing use of a public parking space;
granting a property interest in the public parking space to a private party; and
collecting the fee.

20. The method of claim 19 wherein the parking space is located on a public street.

21. The method of claim 19 wherein the fee associated with the public parking space is determined based, at least in part, on an assessment of the value of a property substantially adjacent to the parking space.

22. The method of claim 19 wherein the property interest is a long-term lease.

23. The method of claim 19 wherein the private party is an institution.

24. The method of claim 23 wherein the institution is one of a hospital or a private school.

25. The method of claim 19 wherein the private party has an existing property interest in property located substantially adjacent to the parking space.

26. The method of claim 19 wherein the fee is collected from the private party to whom the property interest was granted.

27. The method of claim 19 wherein the fee is collected from a financial institution on behalf of the private party.

28. The method of claim 19 wherein the fee is collected upon the granting of the property interest.

29. The method of claim 19 wherein the fee is collected periodically.

30. A method of obtaining an ongoing property interest in a public parking space, comprising:
receiving notification that a property interest in a public parking space is available;
submitting an application to obtain the property interest;
receiving a property interest in a public parking space; and
exercising ongoing control over the use of the parking space.

31. The method of claim 30 wherein the public parking space is located on a public street.

32. The method of claim 30 wherein the property interest is a long-term lease.

33. The method of claim 30 wherein the application includes the opportunity to indicate that the parking space should remain available to the public.

34. The method of claim 30 wherein the exercise of control comprises one or more of subleasing the parking space, selling a timeshare interest in the parking space, or transferring the property interest to another private party.

35. The method of claim 30 further comprising monitoring access to the parking space.

36. The method of claim 35 further comprising notifying a towing service to tow an unauthorized vehicle from the parking space.

37. The method of claim 30 further comprising placing a visible indication of ownership substantially proximate to the parking space.

38. The method of claim 30 further comprising placing an electronic transmitter in one or more vehicles permitted to use the parking space.

39. The method of claim 38 wherein the monitoring comprises the use of wireless electronic detection means.

40. The method of claim 39 wherein the wireless electronic detection means comprises radio frequency identification.

41. The method of claim 30 further comprising placing an electronic monitoring device substantially proximate to the parking space, the device determining if a vehicle is using the parking space.

42. The method of claim 41 wherein the electronic monitoring device further detects if a vehicle using the parking space is permitted to use the parking space.

43. The method of claim 42 further comprising sending an electronic notification from the electronic monitoring device to the selected private party when a vehicle is using the parking space that is not permitted to do so.

44. The method of claim 42 further comprising sending an electronic notification from the electronic monitoring device to a towing service when a vehicle is using the parking space that is not permitted to do so.
